(19) United States
(12) Patent Application Publication
(10) Pub. No.: US 2013/0021885 A1
(43) Pub. Date: Jan. 24, 2013

(54) OPTICAL DISC DRIVE AND METHOD OF DRIVING THE SAME

(71) Applicant: Soon-gyu Jeong, Suwon-si (KR)

(72) Inventor: Soon-gyu Jeong, Suwon-si (KR)

(21) Appl. No.: 13/405,942

(22) Filed: Feb. 27, 2012

(30) Foreign Application Priority Data
Jul. 21, 2011 (KR) 10-2011-0072574

(51) Int. Cl. G11B 20/00

(52) U.S. Cl. 369/47.15; G9B/20

(57) ABSTRACT

Provided are an optical disc drive and a method of driving the same. The optical disc drive may be connected to or become compatible with a host by providing device information and a file system supported by the host to the host that is not compatible with the optical disc drive. The optical disc drive and the method of driving the same become compatible with the host by transmitting information compatible with the host to the host and selecting a specific command set supported by the host.

### CROSS-REFERENCE TO RELATED PATENT APPLICATION(S)

This application claims the benefit under U.S.C. §119(a) of Korean Patent Application No. 10-2011-0072574, filed on Jul. 21, 2011, in the Korean Intellectual Property Office, the entire disclosure of which is incorporated herein in its entirety by reference for all purposes.

### BACKGROUND

1. Field

The following description relates to an optical disc drive which is compatible with a plurality of hosts for reproducing digital content and a method of driving the optical disc drive.

2. Description of the Related Art

Optical disc drives are devices for storing and reproducing information. Examples of optical discs include compact discs (CDs), digital versatile discs (DVDs), blu-ray discs (BDs), and the like. Most DVD storage devices are compatible with CDs that have low capacity. In addition, optical medium storage devices compatible with CDs, DVDs, and BDs have recently been suggested.

Examples of information display devices include general-purpose devices such as computers and television (TV) sets. TV sets are image display devices that may be used to watch various pieces of information in real time. Recently, TV sets have been manufactured to allow peripheral devices to be connected thereto so that various pieces of content stored in the peripheral devices may be displayed using the TV set. TV sets, also referred to as hosts, have a limited connectivity range and compatibility problems with various types of media. For example, such hosts may reproduce digital content such as videos or music by themselves, however, most hosts do not include reproduction software for reproducing music from CDs, that is, reproducing audio of compact disc-digital audios (CD-DAs), and thus, may not reproduce digital content of the CDs.

### SUMMARY

In a general aspect, there is provided an optical disc drive comprising an information processing unit that processes information related to an optical medium, and an interface that connects the information processing unit to an external host. The information processing unit comprises a virtual file generator that generates content in a format that may be reproduced by a host, wherein the format is different from a format of content of the optical medium. The interface may use a universal serial bus (USB) protocol.

The optical disc drive may further comprise a virtual file generator that generates a virtual wave file using content in a raw data format of a compact disc-digital audio (CD-DA).

The optical disc drive may further comprise an interface comprising a file system converter that converts information of a file system in a native format of the optical medium into information of a file system supported by the host. The interface may also convert a native command set of the optical disc drive to a command set supported by the host. The interface may use a wireless protocol. The file system supported by the host may be a file allocation table (FAT) file system.

The optical disc drive may further comprise an optical medium that includes a native file system, which may be a compact disc-digital audio (CD-DA) file system, a file allocation table (FAT) file system, a compact disc file system (CDFS), or a universal disc format (UDF) file system.

In another general aspect, there is provided a method of driving an optical disc drive. The method comprises generating virtual digital content in a format that is different from a specific format of an optical disc mounted in the optical disc drive using digital content, and transmitting the virtual digital content to a host in response to a request of a host to which the optical disc drive is connected.

The method of driving an optical disc drive may further comprise generating virtual digital content in a wave format from content in a compact disc-digital audio (CD-DA) format. A virtual file system may be generated using content information of the optical disc. Further, the virtual file system may be an allocation table (FAT) file system.

The method of driving an optical disc drive may additionally comprise converting information of a file system in a native format of an optical medium mounted in the optical disc drive to information of a file system supported by the host, and transmitting the information of the file system supported by the host in response to a request of the host. In this aspect, a native command set of the optical disc drive may be converted to a command set supported by the host. Further, the file system supported by the host may be a file allocation table (FAT) file system. The optical disc may comprise one of a file allocation table (FAT) format, a compact disc file system (CDFS) format, a universal disc format (UDF), and a compact disc-digital audio (CD-DA) format.

Also, the optical disc drive may exchange information with the host by using a universal serial bus (USB) protocol.

In another general aspect, there is provided an optical disc drive that is connected to a host. The optical disc drive comprises a converter configured to convert data comprising a compact disc-digital audio (CD-DA) format into a virtual file system, and an interface configured to transmit the virtual file system to the host.

Other features and aspects may be apparent from the following detailed description, the drawings, and the claims.

### BRIEF DESCRIPTION OF THE DRAWINGS

FIG. 1 is a diagram illustrating an example of an optical disc drive connected to a host;

FIG. 2 is a diagram illustrating an example of an optical disc drive of FIG. 1;

FIG. 3 is a diagram illustrating an example of a virtual wave file;

FIG. 4 is a diagram illustrating an example of a virtual file allocation table (FAT) file system;

FIG. 5 is a diagram illustrating an example of a connection between a an optical disc drive, which is a slave, and a host, via a universal serial bus (USB) interface;

FIG. 6 is a front view illustrating an example of an optical disc device;

FIG. 7 is a rear view illustrating an example of an optical disc device; and

FIG. 8 is a flowchart illustrating an example of a method of reproducing (accessing) content of at least one type of optical media by using a host.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or system described herein. Accordingly, various changes, modifications, and equivalents of the methods, apparatuses, and/or systems described herein will be suggested to those of ordinary skill in the art. Also, descriptions of well-known functions and construction may be omitted for increased clarity and conciseness.

Typically, a digital content reproduction device such as a TV set does not have the ability to reproduce audio content in a compact disc-digital audio (CD-DA) format. The following relates to an optical disc drive that may provide digital content, for example CD-DA content, to a digital content reproduction device in a format that may be reproduced by the digital content reproduction device. For example, the providing of the digital content may include generating a virtual file system that is supported by the digital content reproduction device.

An audio CD in a CD-DA format, as defined by the Red Book, a standard for CD-DA specifications, includes three regions, that is, a lead-in region, a program region, and a lead-out region. An address of each track is stored in a table of content (TOC) of the lead-in region. Beginning and closing addresses of audio tracks and the audio tracks on which data is actually recorded are located in the program region.

As described herein, an optical disc drive may generate a virtual file, for example, a wave file, and a virtual file system, for example, a file allocation table (FAT) system based on information about the TOC and provide the virtual file and the virtual file system to a reproducer. In addition, the optical disc drive may be compatible with various other discs as well as an audio disc in a CD-DA format.

Optical media as described herein includes all types of general media on which information is physically recorded. Examples of the optical media include CDs, digital versatile discs (DVDs) (e.g., DVD-Rs, DVD-RWs, DVD+Rs, DVD+RWs, and DVD-RAMS), blu-ray discs (BDs), and the like, which each have their native file systems. The optical media may support file systems such as a compact disc file system (CDFS), a universal disc format (UDF) file system, and/or a file allocation table (FAT) file system. The optical media may also support audio that provides raw audio data having a track shape. In an example, the optical media may be mounted in optical disc drives, which may have interfaces connected to external hosts. For example, external hosts may include digital content reproduction devices such as television (TV) sets, set-top boxes, or DivX players. Although the optical media are independent devices, because native functions of the optical media may be performed by the optical disc drives, the optical media may be considered as elements of the optical disc drives.

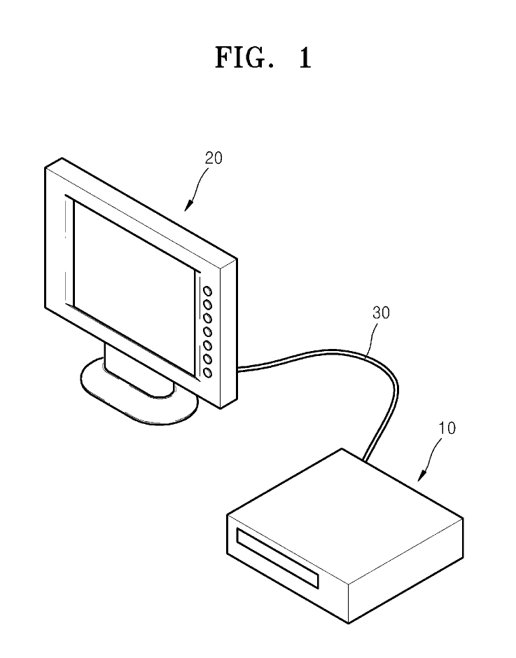

FIG. 1 illustrates an example of an optical disc drive 10 connected to a host 20.

Referring to FIG. 1, the optical disc drive 10 is a slave (a peripheral device) of a host 20, such as the TV set, and is connected to the host 20 via an inter-cable 30. The host 20 may include a decoder for reproducing digital content, for example, a wave file. Although a TV set is an example of the host 20 in FIG. 1, any device for reproducing digital content may be used as the host 20.

Information may be exchanged between interfaces of the optical disc drive 10 and the host 20 via the inter-cable 30, and the interfaces may each include a 1.0, 1.1, 2.0, or 3.0 version universal serial bus (USB) port. That is, a USB cable may be used as the inter-cable 30, and thus the optical disc drive 10 and the host 20 may exchange information by using a USB protocol. As another example, the interfaces may communicate wirelessly without using the inter-cable 30. Examples of wireless include BLUETOOTH®, an ad hoc method, a wireless optical connection method using infrared light, and the like.

The host 20 to which a slave may be connected may support a limited range of file systems. A typical file system is a FAT file system, which is applied to various types of memory cards such as CompactFlash (CF), Secure Digital (SD), MultiMediaCard (MMC), and Memory Stick, as well as hard disc drives (HDDs). Although there are various file systems, the host 20 may not support all of the file systems and may support one or more widely used file systems. Content to be reproduced may be obtained from the slave. However, a host 20 which supports only a FAT file system may not receive content from an optical medium storage device including a CDFS/UDF file system.

The following relates to a method and device, which may connect an optical disc drive to a host 20 that supports a limited range of file systems, such as a TV set, a set-top box, and a Divx player. The optical disc drive may convert a native file system of the optical disc drive into a file system supported by the host, and send the converted file system to the host. For example, the host 20 may reproduce raw audio content by establishing a virtual file and a virtual file system supported by the host 20 using track information from a CD-DA in which no file system exists. While a TV set is described as an example of a digital content reproduction device, the description herein is not limited thereto. Other examples of a digital content reproduction device include a digital photo frame, and the like.

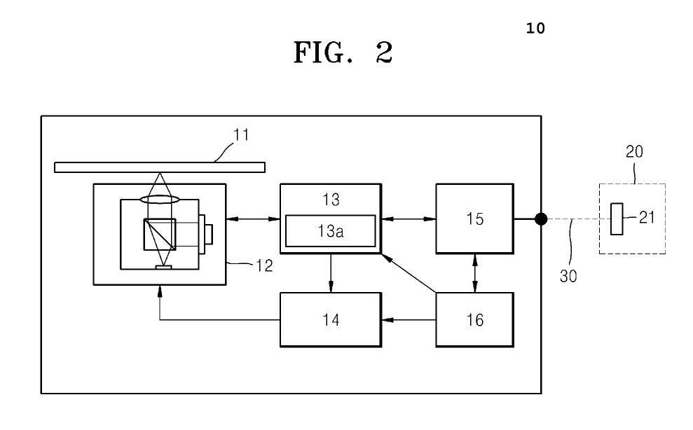

FIG. 2 illustrates an example of the optical disc drive 10 of FIG. 1.

Referring to FIG. 2, the optical disc drive 10 includes an optical pickup 12 for reading or writing information from or to an optical medium 11, an information processing unit 13, a servo unit 14, an interface 15, and a central controller 16.

The optical pickup 12 may include an optical system including one or more of an objective lens, a laser diode (LD), a photodetector, and a mechanical system for mechanically supporting the optical system and performing focusing and tracking. The information processing unit 13 may include an encoder/decoder. In this example, the information processing unit 13 is connected to the interface 15 for connecting the optical disc drive 10 to a host 20, and the servo unit 14 is connected to the mechanical system. The information processing unit 13, the servo unit 14, and the interface 15 may be controlled by the central controller 16. In various examples, the information processing unit 13 may include a virtual file generator 13a for generating content in a format so a host 20 may reproduce content of a CD-DA format obtained from a CD.

Referring to FIG. 2, the interface 15 may include a USB port through which the interface 15 exchanges information with the host 20 using a USB protocol. For example, the host 20 may reproduce content provided from the optical disc drive 10 using a content reproduction device, which may be embedded in the host 20. To provide content, the optical disc drive 10 and the host 20 may exchange information via the interface 15 and an interface 21.

The host 20 may recognize that the optical disc drive 10 is a receivable device, and may receive information of a recognizable file system from the optical disc drive 10. As described herein, a receivable device is a device which a host 20, such as the TV set, a set-top box, or a DivX player, may recognize and access. In an example, receivable device may be used when the host 20 and the receivable device connected to the host 20 use a compatible command set and a compatible file system. A device that may not be accessed by the host 20 is defined as an unknown device and may not exchange information with the host 20.

While the optical disc drive 10 is connected to the host 20, the optical disc drive 10 may transmit information in response to a request of the host 20. However, if the optical disc drive 10 is not compatible with the host 20, the optical disc drive 10 may transmit a code regarding information about a command set mainly used by a block device such as a hard disc drive (HDD), which is a widely compatible and similar medium, by using a converter, which may be embedded in the interface 15. For example, if a CD-DA is used, the optical disc drive 10 may generate a virtual file system that may be recognized by the host 20 and may enable the host 20 to reproduce digital content of the CD-DA using the virtual file system.

According to an example of the USB specification, the optical disc drive 10 may have a device class code 08h in an interface descriptor and belongs to a mass storage device, and may have a subclass code 02h, and thus, may use an MMC-5 (AT attachment packet interface (ATAPI)) command set. However, if a device having a subclass code 02h using an MMC command set, that is, the optical disc drive 10 is a device that is not supported by the host 20, the optical disc drive 10 may not be used. Accordingly, by transmitting a subclass code 06h using a most common SBC (small computer system interface (SCSI) block command to the host 20, the host 20 may recognize the optical disc drive 10 as a usable device. However, if the device having the subclass code 02h is a device that is not supported by the host 20, the subclass code 02h may be transmitted as it is to the host 20. The optical disc drive may be a device having a peripheral device code 05h using an MMC command set. If a host 20 does not support such an MMC command set, the peripheral device code 05 may be converted to code 00h corresponding to a device using a receivable command set, for example, a most common SBC command set. In an example, a most common SBC command set may be a direct-access block device, such as a magnetic disc drive.

In this example, it is assumed that the optical disc drive 10 is recognized by the host 20 as a usable device. Accordingly, if the host 20 requests directory entry information, the optical disc drive 10 may convert information of a file system having a native format of the optical medium 11 to information of a file system having a format which may be recognized by the host 20. The optical disc drive 10 may transmit the converted information of the file system to the host 20. That is, although the optical disc drive 10 has information of a file system not recognizable by the host 20, for example a CD-DA or CDFS/UDF/FAT format, the optical disc drive 10 may convert the information of the file system into information of a file system that is recognizable by the host, for example, a FAT format, in response to a request of the host 20. The optical disc drive 10 may transmit the information of the file system having, for example, the FAT format to the host 20. In various examples, the conversion may be performed using a converter, which may be embedded in the interface 15. Examples of the FAT format include a FAT16 format of 16 bits, a FAT32 format of 32 bits, and the like.

Accordingly, the host 20 may recognize file information, which may include an address of content stored in the optical medium 11, and thus, the host 20 may access and reproduce specific content.

As described herein, a general host may not reproduce digital content that is in a CD-DA format. Accordingly, in various examples herein, the host 20 may access content in the CD-DA format using the aforesaid method, but may not reproduce the content in the CD-DA format. In general, a host 20 that may reproduce digital content may include a decoder for processing a WAV file or an MP3 file except a CD-DA format. In an example, an optical disc drive 10 may convert a CD-DA format into a format which may be processed by a host 20 for reproducing content and may provide the format to the host 20 via an interface 15.

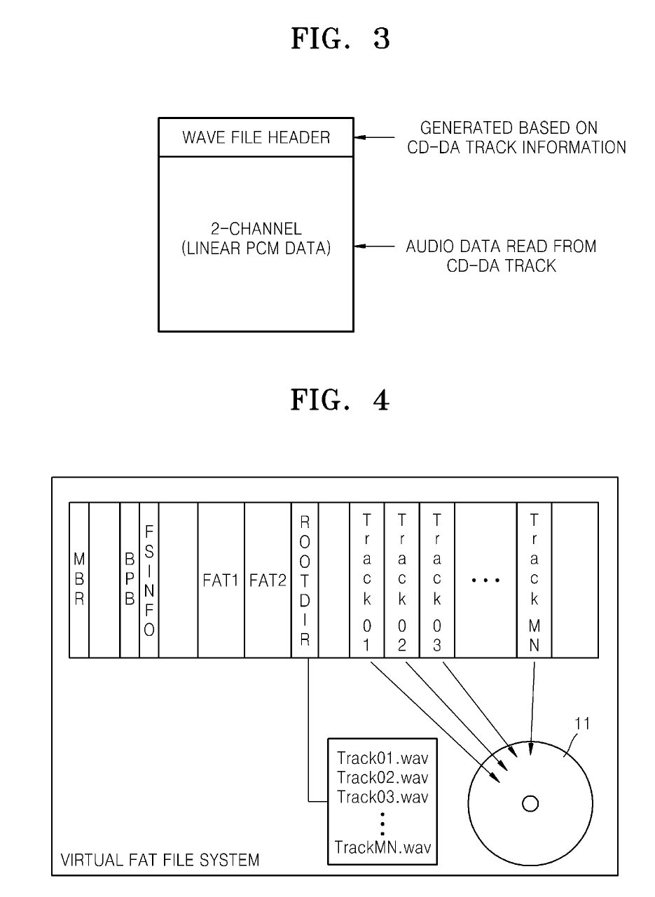

In conventional art, a CD for providing content in a CD-DA format does not include a file system. The optical disc drive 10 may generate a virtual file system using, for example, table of content (TOC) information obtained from the CD. As an example, a CD may include up to 99 tracks, and each of the 99 tracks may include 2-channel 16-bit audio data modulated using linear pulse code modulation (PCM) at a sampling frequency of 44.1 khz. Such data in a CD-DA format may be converted to data in another format. For example, the virtual file generator 13a may generate a virtual wave file, as shown in FIG. 3, using TOC information obtained from a disc in a CD-DA format. A wave file whose extension is “way” may include a file information header and 2-channel linear PCM data. Accordingly, in an example, a wave file header corresponding to each track may be formed using CD track information obtained from TOC information, and audio data may be acquired from the CD track.

FIG. 4 illustrates a virtual FAT file system. Referring to FIG. 4, a root directory ROOTDIR includes a list of virtual files as described above. Files may be generated with names Track01, Track02, . . . , TrackMN (MN is up to 99) according to a track order, and an extension “way” may be used. The information processing unit 13 may transmit request information such as directory information, virtual wave file attribute, or a virtual wave file, in response to a request of the host 20. A header transmitted in this case may be obtained from a CD-DA track, and the files with the names Track01 through TrackMN, which are virtual file data, may be acquired by an optical disc or an optical medium. As such, a virtual wave file may be transmitted via an interface 15 by using a virtual file system, for example, a FAT file system, from an optical disc of a CD-DA format. A host 20 accessing the virtual wave file may reproduce the wave file by using, for example, a decoder embedded therein. In FIG. 4, MBR denotes a master boot record, BPB denotes a BIOS parameter block, and FSINFO denotes file system information.

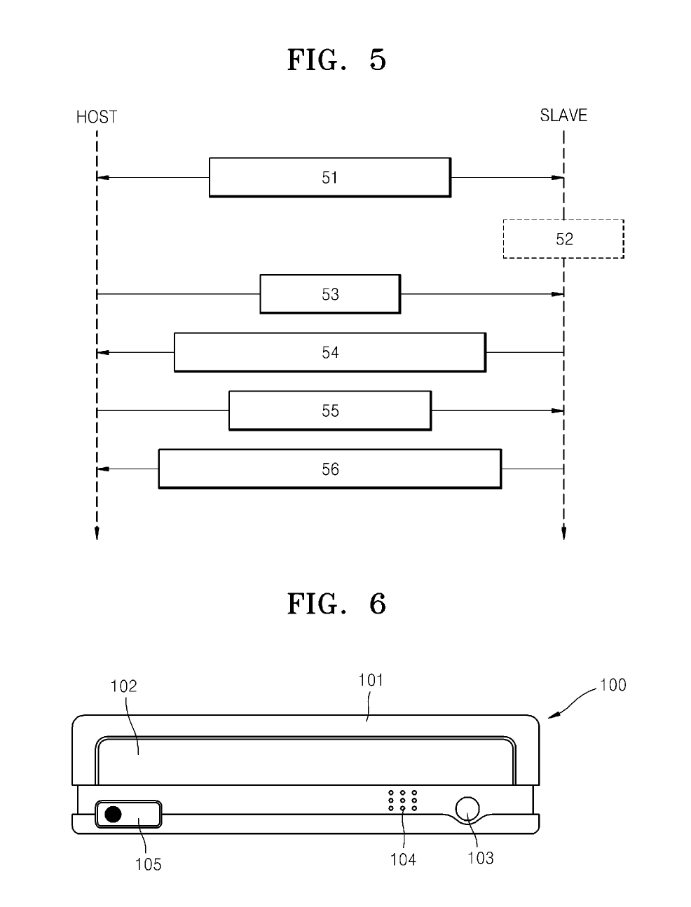

FIG. 5 illustrates an example of a connection between a host HOST and an optical disc drive ODD via a USB interface. Referring to FIG. 5, in 51, the host HOST and the optical disc drive OOD exchange information using a USB. In 52, the optical disc drive ODD, which is a slave device, generates a virtual FAT file system corresponding to a CD-DA or a CDFS/UDF file system. In 53, the host HOST requests information such as a MBR located at a local block address LBA0, which is a first logic block. In 54, the optical disc drive ODD transmits a boost sector and a BIOS parameter block (BPB) of a FAT format to the host HOST. In 55, the host HOST requests a directory entry, and in 56, the optical disc drive ODD transmits directory entry information of a FAT format to the host HOST. The host HOST, which acquires the directory entry information, may know an address of data (content) of the optical disc drive ODD, and may read and reproduce the data by using the address.

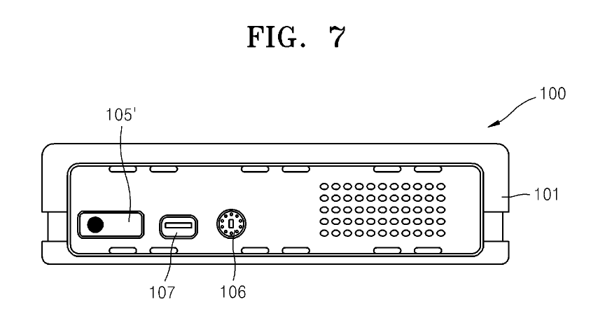

FIGS. 6 and 7 illustrate, respectively, examples of a front view and a rear view of an optical disc drive 100. The optical disc drive 100 may include host select switches 105 and 105′, which are selectively used when the optical disc drive 100 is connected to a host 20, for example, when the host 20 is not compatible with a native file system, and when the optical disc drive 100 is connected to, for example, a personal computer (PC). The optical disc drive 100 may be connected to a PC, which supports CDFS/UDF, which is a native file system format of the optical disc drive 100. The host select switches 105 and 105′ may be connected to an internal circuit of the optical disc drive 100. Further, the host select switches 105 and 105′ may selectively convert device information and may generate, convert, and transmit a file system by using the aforesaid method.

Referring to FIGS. 6 and 7, a front view and a rear view of an optical disc drive 100 may include a main body 101, an optical disc tray 102, a tray opening/closing button 103, a display lamp for displaying an operational state 105, a power terminal 106, and an interface terminal 107, such as a USB port. The optical disc drive 100 shown in FIG. 6 portrays the host select switch 105 provided on a front surface of the optical disc drive 100, and the optical disc drive 100 shown in FIG. 7 portrays the host select switch 105′ provided on a rear surface of the optical disc drive 100.

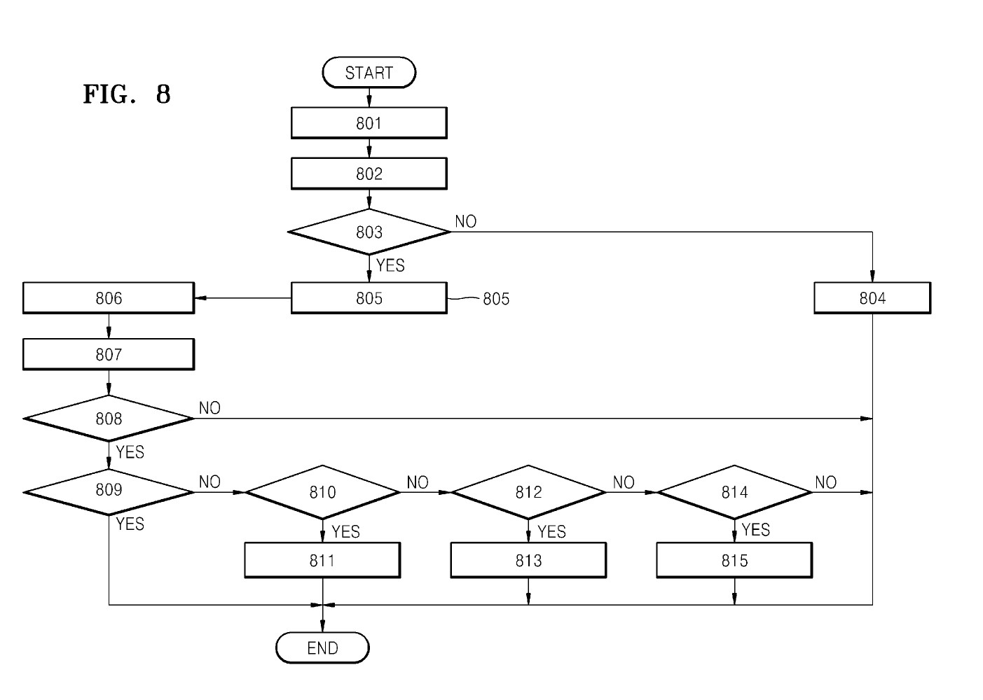

FIG. 8 illustrates a method of reproducing (accessing) content of a FAT, CDFS, UDF, or CD-DA by using a host 20 which may support a file system of a FAT format. Referring to FIG. 8, in operation 801, when an optical disc drive is connected to the host 20, the optical disc drive may be turned on. In operation 802, the optical disc drive may examine states of host select switches 105 and 105′. In operation 803, it may be determined whether the host select switches 105 and 105′ are in an audio/video (AV) mode. If, for example, it is determined in operation 803 that the host select switches 105 and 105′ are not in an AV mode, the method may proceed to operation 804. In operation 804, it may be determined that the host select switches 105 and 105′ may be in a stand-alone mode in which general functions of the host select switches 105 and 105′ are performed, and an existing mode such as a PC mode, may be performed. If it is determined in operation 803 that host select switches 105 and 105′ are in an AV mode, the method may proceed to operation 805. In operation 805, an AV mode may be performed.

Referring to FIG. 8, in order to determine whether a mode is an AV mode, if there is an external switch, the external switch may be used. Alternatively, if there is no external switch, the optical disc drive 10 may use a software method using the fact that processes in which the host 20 and, for example, a PC recognize a USB device are different. In operation 806, a subclass code 02h of a USB interface descriptor may be converted to code 06h which may be a subclass code supported by the host 20, for example, a TV set.

Additionally, a device type may be converted to a device type using a command set supported by the host 20. Referring to FIG. 8, in operation 807, a multimedia local unit having a code 05h using an MMC command set may be converted to a direct-access block device, e.g., a magnetic disc, having a code 00h using an SBC command set.

Further, in operation 808, it may be determined whether an optical medium or an optical disc may be loaded on a disc tray. If it is determined in operation 808 that the optical medium or the optical disc is loaded on the disc tray, the method may proceed to an operation to determine whether there may be a next file system. If it is determined in operation 808 that the optical medium or the optical disc is not loaded on the disc tray, the method may end.

Also, in operation 809, it may be determined whether the optical disc is a disc of, for example, a FAT format. For example, a DVD-RAM may be formatted by using a UDF or FAT file system. If the DVD-RAM is formatted by using a FAT file system, the method may proceed to operation 814. In operation 814, since the FAT format may be supported by the host 20, the method may end. If the DVD-RAM is not formatted by using a FAT file system, the method may proceed to operation 810. In operation 810, it may be determined whether the optical disc is a disc of, for example, a CDFS format. If the optical disc is a disc of a CDFS format, the method may proceed to operation 811. In operation 811, a CDFS of the optical disc drive may be converted to a FAT file system to operate in response to a request of the host 20. If the optical disc is not a disc in a CDFS format, the method may proceed to operation 812. In operation 812, it may be determined whether the optical disc is, for example, a disc in a UDF format. If the optical disc is a disc in a UDF format, the method may proceed to operation 813. In operation 813, a UDF file system may be converted to a FAT file system in response to a request of the host 20.

In operation 814, it may be determined whether the optical disc is, for example, a disc in a CD-DA format. If it is determined in operation 814 that the optical disc is a disc of a CD-DA format, the method may proceed to operation 815. In operation 815, track information may be acquired from a TOC, and a virtual FAT file system may be generated. If it is determined in operation 814 that the optical disc is not a disc in a CD-DA format, the method may proceed to operation 804. In operation 804, a PC mode may be performed.

The host 20 may have information of a FAT file system such as directory entry or FAT from the optical disc drive 10, and thus, may upload and reproduce digital content from the optical disc drive. In an example, if a host 20 may not reproduce a CD-DA format, but rather, may reproduce a wave file, the host 20 may reproduce digital content in a CD-DA format from a CD. The method described herein may be used when access to an optical disc drive 10 may not be allowed, and when access to an optical disc drive 10 may be allowed, but an optical disc in a specific format may not be supported. That is, when a host 20 is not compatible with content of an optical disc drive 10 or a specific optical disc, the method may generate device information and a file system compatible with the host 20. In another example, the method may provide digital content that may be reproduced by the host 20 to the host 20 when a host 20 may not reproduce content of a CD and may reproduce content in another format.

Program instructions to perform a method described herein, or one or more operations thereof, may be recorded, stored, or fixed in one or more computer-readable storage media. The program instructions may be implemented by a computer. For example, the computer may cause a processor to execute the program instructions. The media may include, alone or in combination with the program instructions, data files, data structures, and the like. Examples of computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The program instructions, that is, software, may be distributed over network coupled computer systems so that the software is stored and executed in a distributed fashion. For example, the software and data may be stored by one or more computer readable storage mediums. Also, functional programs, codes, and code segments for accomplishing the example embodiments disclosed herein can be easily construed by programmers skilled in the art to which the embodiments pertain based on and using the flow diagrams and block diagrams of the figures and their corresponding descriptions as provided herein. Also, the described unit to perform an operation or a method may be hardware, software, or some combination of hardware and software. For example, the unit may be a software package running on a computer or the computer on which that software is running.

A number of examples have been described above. Nevertheless, it will be understood by those of ordinary skill in the art that various changes in form and details may be made. For example, suitable results may be achieved if the described techniques are performed in a different order or if components in a described system, architecture, device, or circuit are combined in a different manner or replaced or supplemented by other components or their equivalents. Accordingly, other implementations are within the scope of the following claims.

What is claimed is:

1. An optical disc drive, comprising:
an information processing unit that processes information related to an optical medium, the information processing unit comprising a virtual file generator that generates content in a format that may be reproduced by a host, wherein the format is different from a format of content of the optical medium; and
an interface that connects the information processing unit to an external host.

2. The optical disc drive of claim 1, wherein the virtual file generator generates a virtual wave file using content in a raw data format of a compact disc-digital audio (CD-DA).

3. The optical disc drive of claim 2, wherein the interface comprises a file system converter that converts information of a file system in a native format of the optical medium into information of a file system supported by the host.

4. The optical disc drive of claim 3, wherein the interface converts a native command set of the optical disc drive to a command set supported by the host.

5. The optical disc drive of claim 3, wherein the file system supported by the host is a file allocation table (FAT) file system.

6. The optical disc drive of claim 1, wherein the optical medium includes a native file system, and the native file system is one of a compact disc-digital audio (CD-DA) file system, a file allocation table (FAT) file system, a compact disc file system (CDFS), and a universal disc format (UDF) file system.

7. The optical disc drive of claim 1, wherein the interface uses a universal serial bus (USB) protocol.

8. The optical disc drive of claim 3, wherein the interface uses a wireless protocol.

9. A method of driving an optical disc drive, the method comprising:
generating virtual digital content in a format that is different from a specific format of an optical disc mounted in the optical disc drive using digital content; and
transmitting the virtual digital content to a host, in response to a request of the host to which the optical disc drive is connected.

10. The method of claim 9, wherein the generating of the virtual digital content comprises forming content in a wave format from content in a compact disc-digital audio (CD-DA) format.

11. The method of claim 10, further comprising:
converting information of a file system in a native format of an optical medium mounted in the optical disc drive to information of a file system supported by the host; and
transmitting the information of the file system supported by the host in response to a request of the host.

12. The method of claim 11, wherein a native command set of the optical disc drive is converted to a command set supported by the host.

13. The method of claim 11, wherein the file system supported by the host is a file allocation table (FAT) file system.

14. The method of claim 11, wherein the optical disc comprises one of a file allocation table (FAT) format, a compact disc file system (CDFS) format, a universal disc format (UDF), and a compact disc-digital audio (CD-DA) format.

15. The method of claim 11, wherein the optical disc drive exchanges information with the host using a universal serial bus (USB) protocol.

16. The method of claim 10, wherein a virtual file system is generated using content information of the optical disc.

17. The method of claim 16, wherein the virtual file system is a file allocation table (FAT) file system.

18. An optical disc drive that is connected to a host, the optical disc drive comprising:
a converter configured to convert data comprising a compact disc-digital audio (CD-DA) format into a virtual file system; and
an interface configured to transmit the virtual file system to the host.
